(19) United States
(12) Patent Application Publication
(10) Pub. No.: US 2007/0059607 A1
(43) Pub. Date: Mar. 15, 2007

(54) Cyclic carbonate-modified organosilicon compound, non-aqueous electrolytic solution comprising same, secondary battery, and capacitor

(75) Inventors: Tetsuo Nakanishi, Annaka-shi (JP); Meguru Kashida, Annaka-shi (JP); Satoru Miyawaki, Annaka-shi (JP)

Correspondence Address: BIRCH STEWART KOLASCH & BIRCH, PO BOX 747, FALLS CHURCH, VA, 22040-0747, US

(73) Assignee: Shin-Estu Chemical Co., Ltd.

(21) Appl. No.: 11/514,106

(22) Filed: Sep. 1, 2006

(30) Foreign Application Priority Data
Sep. 13, 2005 (JP) 2005-265551

(51) Int. Cl. H01M 10/40; C07F 7/04; C07F 7/00; C07F 7/08

(52) U.S. Cl. 429/330; 556/436; 556/443; 556/465

(57) ABSTRACT

A cyclic carbonate-modified silane or siloxane is combined with a non-aqueous solvent and an electrolyte salt to form a non-aqueous electrolytic solution, which is used to construct a secondary battery having improved temperature and cycle characteristics.

### CROSS-REFERENCE TO RELATED APPLICATION

This non-provisional application claims priority under 35 U.S.C. §119(a) on Patent Application No. 2005-265551 filed in Japan on Sep. 13, 2005, the entire contents of which are hereby incorporated by reference.

### TECHNICAL FIELD

This invention relates to a cyclic carbonate-modified organosilicon compound and a non-aqueous electrolytic solution comprising the same. It also relates to energy devices using the electrolytic solution, specifically secondary batteries and electrochemical capacitors, and especially lithium ion secondary batteries.

### BACKGROUND ART

Because of their high energy density, lithium ion secondary batteries are increasingly used in recent years as portable rechargeable power sources for laptop computers, mobile phones, digital cameras, digital video cameras, and the like. Also great efforts are devoted to the development of lithium ion secondary batteries and electric double-layer capacitors using non-aqueous electrolytic solution, as auxiliary power sources for electric and hybrid automobiles which are desired to reach a practically acceptable level as environment-friendly automobiles.

The lithium ion secondary batteries, albeit their high performance, are not satisfactory with respect to discharge characteristics in a rigorous environment, especially low-temperature environment, and discharge characteristics at high output levels requiring a large quantity of electricity within a short duration of time. On the other hand, the electric double-layer capacitors suffer from problems including insufficient withstand voltages and a decline with time of their electric capacity. Most batteries use non-aqueous electrolytic solutions based on low-flash-point solvents, typically dimethyl carbonate and diethyl carbonate. In case of thermal runaway in the battery, the electrolytic solution will vaporize and be decomposed, imposing the risk of battery rupture and ignition. Then, IC circuits are generally incorporated in the batteries as means for breaking currents under abnormal conditions, and safety valves are also incorporated for avoiding any rise of the battery internal pressure by the evolution of hydrocarbon gases. It is thus desired to further elaborate the electrolytic solutions for the purposes of safety improvement, weight reduction, and cost reduction.

Under the circumstances, polyether-modified siloxanes are of great interest because they are chemically stable and compatible with electrolytic solutions. Due to their ability to help dissolve electrolytes such as LiPF₆ thoroughly and their inherent surface activity, the polyether-modified siloxanes are effective in improving the wetting of electrodes or separators. It is also known that adding only a few percents of polyether-modified siloxane to electrolytic solutions improves the charge/discharge cycle performance. However, these effects are yet insufficient. Besides, the polyether-modified siloxanes lack thermal stability and additionally, have a relatively high melting point so that they encounter some problems during low-temperature service. It would be desirable to have additives which are more stable and more compatible with electrolytic solutions.

Reference should be made to JP-A 11-214032, JP-A 2000-58123 both corresponding to U.S. Pat. No. 6,124,062, JP-A 2001-110455, and JP-A 2003-142157.

### DISCLOSURE OF THE INVENTION

An object of the present invention is to provide a non-aqueous electrolytic solution which enables construction of batteries (especially lithium ion secondary batteries) or electrochemical capacitors (such as electric double-layer capacitors) having improved discharge characteristics both at low temperatures and at high outputs as well as improved safety. Another object is to provide a cyclic carbonate-modified organosilicon compound which is effective for use therein. A further object is to provide secondary batteries using the same, specifically lithium ion secondary batteries and electrochemical capacitors.

The inventors have discovered that when cyclic carbonate-modified silanes or siloxanes are synthesized using specific cyclic carbonates as one reactant, this synthesis is performed in high yields and at low costs; and that non-aqueous electrolytic solutions comprising the same offer improved charge/discharge cycle performance and safety.

Specifically, the inventors made research if carbonate-modified silicones using ethylene carbonate having a vinyl radical as a functional radical could be a substitute for the polyether-modified silicones. Unfortunately, vinyl ethylene carbonate undergoes decarboxylation reaction during addition reaction with a SiH-bearing siloxane, forming alkoxysiloxane by-products, as shown by the reaction scheme below. 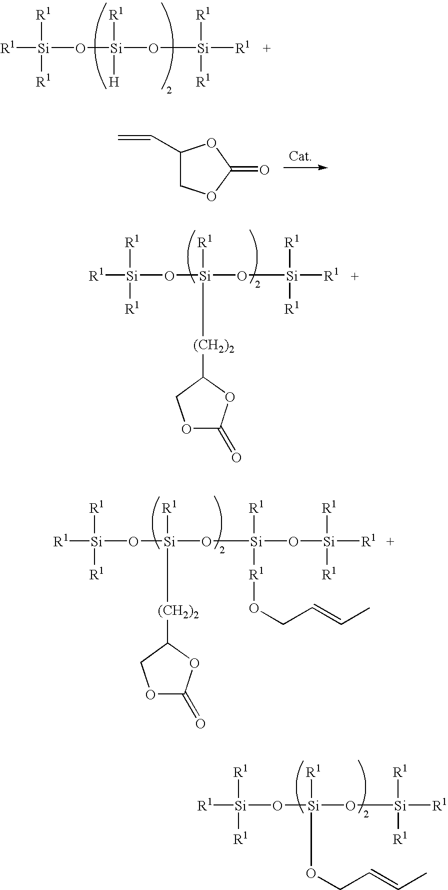
This necessitates steps of separating and purifying from the reaction product. It is thus difficult to synthesize modified or branched siloxanes with a high degree of polymerization, and the synthesis by way of addition reaction is limited to siloxanes with a low degree of polymerization. Needed are new methods for synthesizing siloxanes with a low degree of polymerization and modified siloxanes or branched modified siloxanes with a high degree of polymerization in high yields. The inventors have found that the cyclic carbonate-modified silanes and siloxanes of formulae (1) and (2) can be synthesized by the method to be described below and meet the outstanding needs; and that when the cyclic carbonate-modified silanes and/or siloxanes are used in non-aqueous electrolytic solutions for batteries or capacitors, improved temperature and cycle characteristics are observed.

Accordingly, the present invention in one aspect provides a cyclic carbonate-modified organosilicon compound having the general formula (1) or (2):
R¹₍₄₋ₓ₎AₓSi (1)
R¹ₐA_{b}SiO_{(4-a-b)/2} (2)
wherein R¹ is each independently a monovalent radical selected from among hydroxyl radicals, and alkyl, aryl, aralkyl, amino-substituted alkyl, carboxyl-substituted alkyl, alkoxy, and aryloxy radicals of 1 to 30 carbon atoms which may be substituted with one or more halogens, A is a cyclic carbonate radical of the general formula (3): 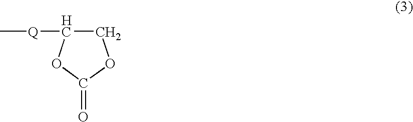
wherein Q is a divalent organic radical of 3 to 20 carbon atoms which may contain an ether or ester bond, the subscript x is an integer of 1 to 4, a is a positive number of 1.0 to 2.5, b is a positive number of 0.001 to 1.5, and the sum of a+b is from 1.001 to 3.

The present invention also provides a non-aqueous electrolytic solution comprising a non-aqueous solvent, an electrolyte salt, and the cyclic carbonate-modified organosilicon compound described above. The present invention also provides a secondary battery, especially lithium ion secondary battery, and an electrochemical capacitor, comprising the non-aqueous electrolytic solution defined above. In the lithium ion secondary battery comprising a positive electrode, a negative electrode, a separator, and the non-aqueous electrolytic solution of the invention, charging/discharging operation occurs through migration of lithium ions between positive and negative electrodes.

### BENEFITS OF THE INVENTION

Batteries using the non-aqueous electrolytic solution comprising a cyclic carbonate-modified silane and/or siloxane according to the invention exhibit improved temperature and cycle characteristics.

### BRIEF DESCRIPTION OF THE DRAWING

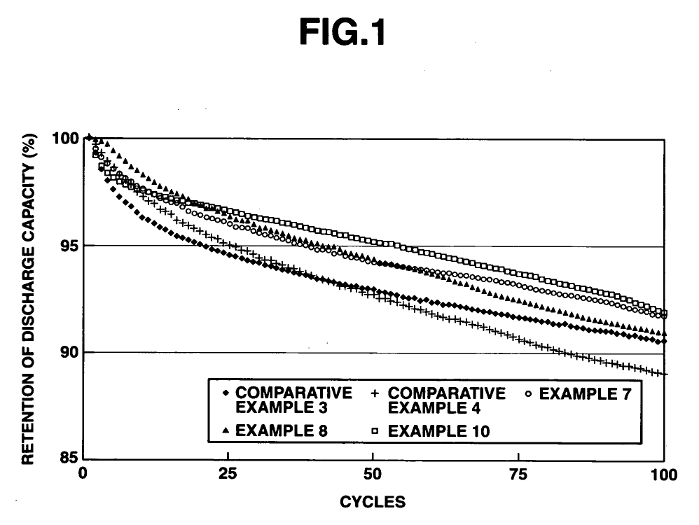

The only FIGURE, FIG. 1 is a graph of discharge capacity retention versus cycles in Examples 7, 8, 10 and Comparative Example 3.

### DESCRIPTION OF THE PREFERRED EMBODIMENTS

The cyclic carbonate-modified organosilicon compounds (silanes and siloxanes) used in non-aqueous electrolytic solutions according to the invention have the general formulae (1) and (2).
R¹₍₄₋ₓ₎AₓSi (1)
R¹ₐA_{b}SiO_{(4-a-b)/2} (2)
Herein R¹ may be the same or different and is selected from among hydroxyl radicals, and alkyl radicals, aryl radicals, aralkyl radicals, amino-substituted alkyl radicals, carboxyl-substituted alkyl radicals, alkoxy radicals, and aryloxy radicals of 1 to 30 carbon atoms which may be substituted with one or more halogens. Examples include hydroxyl radicals, alkyl radicals such as methyl, ethyl, propyl, isopropyl, butyl, isobutyl, tert-butyl, pentyl, cyclopentyl, hexyl, cyclohexyl, heptyl, octyl, nonyl, and decyl; aryl radicals such as phenyl and tolyl; aralkyl radicals such as benzyl and phenethyl; amino-substituted alkyl radicals such as 3-aminopropyl and 3-[(2-aminoethyl)amino]propyl; and carboxy-substituted alkyl radicals such as 3-carboxypropyl. Also included are halogenated alkyl radicals in which some hydrogen atoms are substituted by halogen atoms, such as trifluoropropyl and nonafluorooctyl. Suitable alkoxy radicals include methoxy, ethoxy, propoxy, and isopropoxy. A typical aryloxy radical is phenoxy. Of these, alkyl and fluoroalkyl radicals of 1 to 6 carbon atoms are preferred. Methyl and ethyl are most preferred. It is especially preferred that at least 80 mol % of R¹ be methyl or ethyl.

A is a cyclic carbonate radical of the general formula (3). 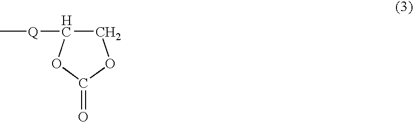
Herein Q is a divalent organic radical of 3 to 20 carbon atoms which may be straight or branched and contain an ether or ester bond, specifically selected from among divalent aliphatic and aromatic hydrocarbon radicals such as alkylene radicals, arylene radicals and combinations thereof. Suitable organic radicals include straight or branched alkylene radicals such as —(CH₂)₃—, —(CH₂)₄—, —CH₂CH(CH₃)CH₂—, —(CH₂)₅—, —(CH₂)₆—, —(CH₂)₇—, —(CH₂)₈—, —(CH₂)₂—CH(CH₂CH₂CH₃)—, and —CH₂—CH(CH₂CH₃)—; straight or branched oxyalkylene radicals such as —(CH₂)₃—O—CH₂—, —(CH₂)₃—O—(CH₂)₂—, —(CH₂)₃—O—(CH₂)₂—O—(CH₂)₂—, and —(CH₂)₃—O—CH₂CH(CH₃)—; and straight or branched, ester-containing alkylene radicals such as —CH₂—CH(CH₃)—COO(CH₂)₂—. Also included are substituted forms of the foregoing in which some or all hydrogen atoms are substituted by fluorine atoms, such as perfluoroether radicals. Of these, trimethylene and —(CH₂)₃—O—CH₂— are most preferred for the availability of starting reactants and ease of synthesis.

The subscript x is an integer of 1 to 4. It is preferred that x be equal to 1 or 2, and especially equal to 1, because if x is 3 or 4, the carbonate content is relatively increased to detract from silane or siloxane characteristics.

The subscript “a” is a positive number of 1.0≦a≦2.5, preferably 1.5≦a≦2.5. If a<1.0, the carbonate-modified siloxane may have a viscosity high enough to reduce the ion mobility in the electrolytic solution and no improvement in wetting be expected sometimes. If a>2.5, the siloxane may become less compatible with electrolytic solution and difficult to facilitate stable dissolution of the electrolyte. The subscript “b” is a positive number of 0.001≦b≦1.5, preferably 0.1≦b≦1.0. If b<0.001, the carbonate-modified siloxane may have a reduced carbonate content and may become less compatible with electrolytic solution and difficult to facilitate stable dissolution of the electrolyte. If b>1.5, the carbonate-modified siloxane may have a viscosity high enough to reduce the ion mobility in the electrolytic solution and no improvement in wetting be expected sometimes. The sum of a+b is in a range of 1.001≦a+b≦3, preferably 1.1≦a+b≦2.7, and more preferably 1.5≦a+b≦2.5.

The cyclic carbonate-modified siloxanes of the invention should preferably have a weight average molecular weight (Mw) of less than or equal to about 100,000, as measured by gel permeation chromatography (GPC) versus polystyrene standards. Larger molecular weights generally correspond to higher viscosities, leading to a drop of ion mobility in the electrolytic solution. Sometimes, no improvement in wetting may be expected. For these reasons, the Mw is preferably less than or equal to about 10,000. In an embodiment where the cyclic carbonate-modified siloxane is used alone as a non-aqueous solvent without using an ordinary non-aqueous solvent, it should preferably have a viscosity less than or equal to 100 mPa-s, which suggests a preferred molecular weight less than or equal to 1,000. The lower limit of molecular weight is preferably at least 150, especially at least 200.

The cyclic carbonate-modified silanes (1) and siloxanes (2) can be obtained through addition reaction of an organohydrogensilane or organohydrogenpolysiloxane having a silicon-bonded hydrogen atom (i.e., SiH radical) with a cyclic carbonate having a carbon-to-carbon double bond. For example, a desired compound may be obtained through addition reaction of a SiH-bearing siloxane with allyl ethylene carbonate (i.e., 4-allyl-1,3-dioxolan-2-one). It is noted that allyl ethylene carbonate having formula (i) shown below can be synthesized by several methods, for example, reaction of 4-pentene-1,2-diol with phosgene, reaction of 4-pentene-1,2-diol with ethyl chloroformate in the presence of pyridine, reaction of 4-pentene-1,2-diol with a dialkyl carbonate in the presence of potassium carbonate, reaction of 4-pentene-1,2-diol with urea, and addition reaction of carbon dioxide to 2-allyloxysilane in the presence of pyridine. Similarly, using glycerin monoallyl ether (4-allyloxy-propane-1,2-diol) instead of 4-pentene-1,2-diol, allyloxy propylene carbonate having formula (ii) shown below can be synthesized. The allyloxy propylene carbonate is cost effective and thus most preferred because the starting reactant, glycerin monoallyl ether is less expensive than the starting reactant for the allyl ethylene carbonate, 4-pentene-1,2-diol.

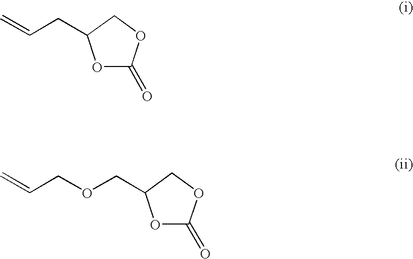

Desirably the addition reaction is effected in the presence of a platinum or rhodium catalyst. Suitable catalysts used herein include chloroplatinic acid, alcohol-modified chloroplatinic acid, and chloroplatinic acid-vinyl siloxane complexes. Further sodium acetate or sodium citrate may be added as a co-catalyst or pH buffer. The catalyst is used in a catalytic amount, and preferably such that platinum or rhodium is present in an amount of up to 50 ppm, more preferably up to 20 ppm, relative to the total weight of the SiH-bearing siloxane and the vinyl ethylene carbonate.

If desired, the addition reaction may be effected in an organic solvent. Suitable organic solvents include aliphatic alcohols such as methanol, ethanol, 2-propanol and butanol; aromatic hydrocarbons such as toluene and xylene; aliphatic or alicyclic hydrocarbons such as n-pentane, n-hexane, and cyclohexane; and halogenated hydrocarbons such as dichloromethane, chloroform and carbon tetrachloride.

Addition reaction conditions are not particularly limited. Typically addition reaction is effected under reflux for about 1 to 10 hours.

In an alternative process, the cyclic carbonate-modified siloxane (2) can be obtained through hydrolytic condensation of a cyclic carbonate-modified silane having a hydrolyzable radical such as hydrogen, hydroxyl, alkoxy or halogen, or a mixture of hydrolyzable silanes. The reactive silanes having a hydrolyzable radical(s) are exemplified below. Examples of hydrolyzable silanes having hydrogen atoms include trimethylsilane, dimethylsilane and methylsilane. Examples of hydrolyzable silanes having hydroxyl radicals include trimethylsilanol, dimethyldisilanol, and methyltrisilanol. Examples of hydrolyzable silanes having alkoxy radicals include trimethylmethoxysilane, dimethyldimethoxysilane, methyltrimethoxysilane, and tetramethoxysilane, provided that the alkoxy radical is methoxy, for example. Examples of hydrolyzable silanes having halogen atoms include trimethylchlorosilane, dimethyldichlorosilane, methyltrichlorosilane, and tetrachlorosilane.

The hydrolytic reaction may be conducted by well-known techniques and under ordinary conditions. In general, the amount of water used per mole of the hydrolyzable radical-bearing cyclic carbonate-modified silane is preferably 0.3 to 3 moles, especially 0.4 to 2.4 moles, depending on the moles of hydrolyzable radicals per molecule of the cyclic carbonate-modified silane. In this case, an organic solvent such as an alcohol may be used as a compatibilizing agent in an amount of 0.2 to 100 moles per mole of said silane. Suitable hydrolytic catalysts are acidic catalysts including mineral acids such as sulfuric acid, methanesulfonic acid, hydrochloric acid, and phosphoric acid, and carboxylic acids such as formic acid, acetic acid, and trifluoroacetic acid; and alkaline catalysts including hydroxides of alkali and alkaline earth metals such as sodium hydroxide, potassium hydroxide, and magnesium hydroxide. The catalyst is used in a catalytic amount and usually in an amount of about 0.1% to about 10% by weight of the overall reaction solution. The reaction temperature is in a range of −50° C. to 40° C., especially −20° C. to 20° C., and the reaction time is generally from about 1 hour to about 10 hours.

The hydrolytic reaction is carried out, for example, by previously synthesizing an addition reaction product of trimethoxysilane (H(MeO)₃Si), methyldimethoxysilane (HMe(MeO)₂Si) and dimethylmethoxysilane (HMe₂(MeO)Si) with allyl ethylene carbonate. The reaction product is then combined with an alkoxysilane selected from among tetramethoxysilane, methyltrimethoxysilane, dimethyldimethoxysilane and trimethylmethoxysilane, and subjected to hydrolysis in the presence of sulfuric acid or methanesulfonic acid. This is also true when the alkoxy radical is ethoxy. In the event the halogenated silane is used, a halogenated carbonate silane is synthesized through the above-described addition reaction and then added dropwise to a large volume of water together with a chlorosilane of proper choice. In any of these reaction routes, a solvent such as alcohol is conveniently used as a compatibilizing agent. Since the reaction is exothermic, the reaction system is preferably cooled at about 0° C.

Illustrative examples of the cyclic carbonate-modified silanes (1) and cyclic carbonate-modified siloxanes (2) include compounds [I] through [IX] shown below.

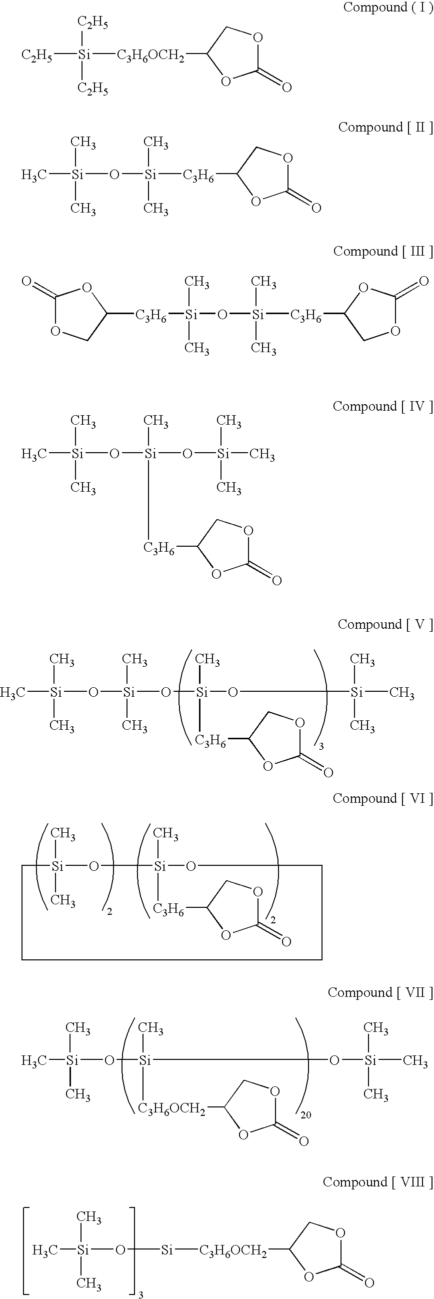

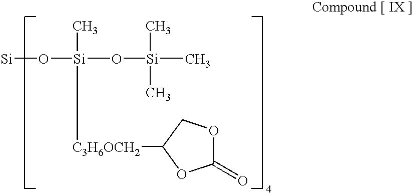

The present invention also provides a non-aqueous electrolytic solution comprising one or more cyclic carbonate-modified organosilicon compounds (silanes having formula (1) and/or siloxanes having formula (2)). In addition to the cyclic carbonate-modified organosilicon compound, the non-aqueous electrolytic solution contains a non-aqueous solvent and an electrolyte salt.

In the non-aqueous electrolytic solution, the cyclic carbonate-modified organosilicon compound should preferably be present in an amount of at least 0.001% by volume. If the content is less than 0.001% by volume, the desired effect may not be exerted. The preferred content is at least 0.1% by volume. The upper limit of the content varies with the type of a particular solvent used in the non-aqueous electrolytic solution, but should be determined such that migration of Li ions within the non-aqueous electrolytic solution is at or above the practically acceptable level. The content is usually up to 80% by volume, preferably up to 60% by volume, and more preferably up to 50% by volume of the non-aqueous electrolytic solution. Meanwhile, it is acceptable that the silane or siloxane content in the non-aqueous electrolytic solution be 100% by volume, with any volatile solvent commonly used in non-aqueous electrolytic solutions of this type being omitted.

The non-aqueous electrolytic solution of the invention further contains an electrolyte salt and a non-aqueous solvent. Exemplary of the electrolyte salt used herein are light metal salts. Examples of the light metal salts include salts of alkali metals such as lithium, sodium and potassium, salts of alkaline earth metals such as magnesium and calcium, and aluminum salts. A choice may be made among these salts and mixtures thereof depending on a particular purpose. Examples of suitable lithium salts include LiBF₄, LiClO₄, LiPF₆, LiAsF₆, CF₃SO₃Li, (CF₃SO₂)₂NLi, C₄F₉SO₃Li, CF₃CO₂Li, (CF₃CO₂)₂NLi, C₆F₅SO₃Li, C₈F₁₇SO₃Li, (C₂F₅SO₂)₂NLi, (C₄F₉SO₂)(CF₃SO₂)NLi, (FSO₂C₆F₄)(CF₃SO₂)NLi, ((CF₃)₂CHOSO₂)₂NLi, (CF₃SO₂)₃CLi, (3,5-(CF₃)₂C₆F₃)₄BLi, LiCF₃, LiAlC₄, and C₄BO₈Li, which may be used alone or in admixture.

From the electric conductivity aspect, the electrolyte salt is preferably present in a concentration of 0.5 to 2.0 mole/liter of the non-aqueous electrolytic solution. The electrolytic solution should preferably have a conductivity of at least 0.01 S/m at a temperature of 25° C., which may be adjusted in terms of the type and concentration of the electrolyte salt.

The non-aqueous solvent used herein is not particularly limited as long as it can serve for the non-aqueous electrolytic solution. Suitable solvents include aprotic high-dielectric-constant solvents such as ethylene carbonate, propylene carbonate, butylene carbonate, and γ-butyrolactone; and aprotic low-viscosity solvents such as dimethyl carbonate, ethyl methyl carbonate, diethyl carbonate, methyl propyl carbonate, dipropyl carbonate, diethyl ether, tetrahydrofuran, 1,2-dimethoxyethane, 1,2-diethoxyethane, 1,3-dioxolane, sulfolane, methylsulfolane, acetonitrile, propionitrile, anisole, acetic acid esters, e.g., methyl acetate and propionic acid esters. It is desirable to use a mixture of an aprotic high-dielectric-constant solvent and an aprotic low-viscosity solvent in a proper ratio. It is also acceptable to use ionic liquids containing imidazolium, ammonium and pyridinium cations. The counter anions are not particularly limited and include BF₄⁻, PF₆⁻ and (CF₃SO₂)₂N⁻. The ionic liquid may be used in admixture with the foregoing non-aqueous solvent.

Where a solid electrolyte or gel electrolyte is desired, a silicone gel, silicone polyether gel, acrylic gel, acrylonitrile gel, poly(vinylidene fluoride) or the like may be included in a polymer form. These ingredients may be polymerized prior to or after casting. They may be used alone or in admixture.

If desired, various additives may be added to the non-aqueous electrolytic solution of the invention. Examples include an additive for improving cycle life such as vinylene carbonate, methyl vinylene carbonate, ethyl vinylene carbonate and 4-vinylethylene carbonate, an additive for preventing over-charging such as biphenyl, alkylbiphenyl, cyclohexylbenzene, t-butylbenzene, diphenyl ether, and benzofuran, and various carbonate compounds, carboxylic acid anhydrides, nitrogen- and sulfur-containing compounds for acid removal and water removal purposes.

A further embodiment of the present invention is a secondary battery comprising a positive electrode, a negative electrode, a separator, and an electrolytic solution, wherein the non-aqueous electrolytic solution described above is used as the electrolytic solution.

The positive electrode active materials include oxides and sulfides which are capable of occluding and releasing lithium ions. They may be used alone or in admixture. Examples include sulfides and oxides of metals excluding lithium such as TiS₂, MoS₂, NbS₂, ZrS₂, VS₂, V₂O₅, MoO₃, Mg(V₃O₈)₂, and lithium and lithium-containing complex oxides. Composite metals such as NbSe₂ are also useful. For increasing the energy density, lithium complex oxides based on LiₚMetO₂ are preferred wherein Met is preferably at least one element of cobalt, nickel, iron and manganese and p has a value in the range: 0.05≦p≦1.10. Illustrative examples of the lithium complex oxides include LiCoO₂, LiNiO₂, LiFeO₂, and Li_{q}NiᵣCo₁₋ᵣO₂ (wherein q and r have values varying with the charged/discharged state of the battery and usually in the range: 0<q<1 and 0.7<r≦1) having a layer structure, LiMn₂O₄ having a spinel structure, and rhombic LiMnO₂. Also used is a substitutional spinel type manganese compound adapted for high voltage operation which is LiMetₛMn₁₋ₛO₄ wherein Met is titanium, chromium, iron, cobalt, nickel, copper, zinc or the like and s has a value in the range: 0<s<1.

It is noted that the lithium complex oxide described above is prepared, for example, by grinding and mixing a carbonate, nitrate, oxide or hydroxide of lithium and a carbonate, nitrate, oxide or hydroxide of a transition metal in accordance with the desired composition, and firing at a temperature in the range of 600 to 1,000° C. in an oxygen atmosphere.

Organic materials may also be used as the positive electrode active material. Examples include polyacetylene, polypyrrole, poly-p-phenylene, polyaniline, polythiophene, polyacene, and polysulfide.

The negative electrode materials capable of occluding and releasing lithium ions include carbonaceous materials, metal elements and analogous metal elements, metal complex oxides, and polymers such as polyacetylene and polypyrrole.

Suitable carbonaceous materials are classified in terms of carbonization process, and include carbon species and synthetic graphite species synthesized by the gas phase process such as acetylene black, pyrolytic carbon and natural graphite; carbon species synthesized by the liquid phase process including cokes such as petroleum coke and pitch coke; pyrolytic carbons obtained by firing polymers, wooden materials, phenolic resins, and carbon films; and carbon species synthesized by the solid phase process such as charcoal, vitreous carbons, and carbon fibers.

Also included in the negative electrode materials capable of occluding and releasing lithium ions are metal elements and analogous metal elements capable of forming alloys with lithium, in the form of elements, alloys or compounds. Their state includes a solid solution, eutectic, and intermetallic compound, with two or more states being optionally co-present. They may be used alone or in admixture of two or more.

Examples of suitable metal elements and analogous metal elements include tin, lead, aluminum, indium, silicon, zinc, copper, cobalt, antimony, bismuth, cadmium, magnesium, boron, gallium, germanium, arsenic, selenium, tellurium, silver, hafnium, zirconium and yttrium. Inter alia, Group 4B metal elements or analogous metal elements in element, alloy or compound form are preferred. More preferred are silicon and tin or alloys or compounds thereof. They may be crystalline or amorphous.

Illustrative examples of such alloys and compounds include LiAl, AlSb, CuMgSb, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, composite Si/SiC, Si₃N₄, Si₂N₂O, SiOᵥ (wherein 0<v≦2), composite SiO/C, SnO_{w} (wherein 0<w≦2), SnSiO₃, LiSiO and LiSnO.

Any desired method may be used in the preparation of positive and negative electrodes. Electrodes are generally prepared by adding an active material, binder, conductive agent and the like to a solvent to form a slurry, applying the slurry to a current collector sheet, drying and press bonding. The binder used herein is usually selected from polyvinylidene fluoride, polytetrafluoroethylene, styrene-butadiene rubber, isoprene rubber, and various polyimide resins. The conductive agent used herein is usually selected from carbonaceous materials such as graphite and carbon black, and metal materials such as copper and nickel. As the current collector, aluminum and aluminum alloys are usually employed for the positive electrode, and metals such as copper, stainless steel and nickel and alloys thereof employed for the negative electrode.

The separator disposed between the positive and negative electrodes is not particularly limited as long as it is stable to the electrolytic solution and holds the solution effectively. The separator is most often a porous sheet or non-woven fabric of polyolefins such as polyethylene and polypropylene. Porous glass and ceramics are employed as well.

The secondary battery may take any desired shape. In general, the battery is of the coin type wherein electrodes and a separator, all punched into coin shape, are stacked, or of the cylinder type wherein electrode sheets and a separator are spirally wound.

The non-aqueous electrolytic solution of the invention is also applicable to electrochemical capacitors comprising electrodes, a separator, and an electrolytic solution, especially electric double-layer capacitors or pseudo-electric double-layer capacitors, asymmetrical capacitors, and redox capacitors.

At least one of the electrodes in the capacitors is a polarizable electrode composed mainly of a carbonaceous material. The polarizable electrode is generally formed of a carbonaceous material, a conductive agent, and a binder. The polarizable electrode is prepared according to the same formulation as used for the lithium secondary battery. For example, it is prepared by mixing a powder or fibrous activated carbon with the conductive agent such as carbon black or acetylene black, adding polytetrafluoroethylene as the binder, and applying or pressing the mixture to a current collector of stainless steel or aluminum. Similarly, the separator and the electrolytic solution favor highly ion permeable materials, and the materials used in the lithium secondary battery can be used substantially in the same manner. The shape may be coin, cylindrical or rectangular.

### EXAMPLE

Examples of the present invention are given below for further illustrating the invention, but they are not to be construed as limiting the invention thereto. The viscosity is measured at 25° C. by a rotational viscometer.

### Example 1

A reactor equipped with a stirrer, thermometer and reflux condenser was charged with 32 g of allyl ethylene carbonate, 100 g of toluene, and 0.05 g of a 0.5 wt % chloroplatinic acid toluene solution. With stirring at 70° C., 41 g of pentamethyldisiloxane was added dropwise to the mixture. Reaction took place while the molar ratio of terminal unsaturated radicals to SiH radicals was about 0.9. After the completion of dropwise addition, the reaction solution was aged at 80° C. for 2 hours to complete the reaction. The reaction solution was precision distilled in vacuum, collecting a fraction of 145° C./50 Pa. In this way, a cyclic carbonate-modified siloxane was obtained in a yield of 90%. It had a viscosity of 15 mPa-s, a specific gravity of 0.991, and a purity of 99.2% as analyzed by gas chromatography. On analysis by ¹H-NMR using heavy acetone as the measuring solvent, the peaks observed included 0.1 ppm (15H, s), 0.61 ppm (2H, m), 1.50 ppm (2H, m), 1.80 ppm (2H, m), 4.12 ppm (1H, dd), 4.60 ppm (1H, dd), and 4.81 ppm (1H, tt). From these data, the product was identified to be a cyclic carbonate-modified siloxane having the following formula (Compound [II]).

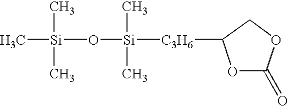

### Example 2

A reactor equipped with a stirrer, thermometer and reflux condenser was charged with 26 g of allyl ethylene carbonate, 100 g of toluene, and 0.05 g of a 0.5 wt % chloroplatinic acid toluene solution. With stirring at 70° C., 49 g of 1,1,1,3,5,5,5-heptamethyltrisiloxane was added dropwise to the mixture. Reaction took place while the molar ratio of terminal unsaturated radicals to SiH radicals was about 0.9. After the completion of dropwise addition, the reaction solution was aged at 80° C. for 2 hours to complete the reaction. The reaction solution was precision distilled in vacuum, collecting a fraction of 156° C./50 Pa. In this way, a cyclic carbonate-modified siloxane was obtained in a yield of 97%. It had a viscosity of 16 mPa-s, a specific gravity of 0.985, and a purity of 96.2% as analyzed by gas chromatography. On analysis by ¹H-NMR using heavy acetone as the measuring solvent, the peaks observed included 0.1 ppm (21H, ss), 0.55 ppm (2H, m), 1.51 ppm (2H, m), 1.81 ppm (2H, m), 4.12 ppm (1H, dd), 4.60 ppm (1H, dd), and 4.81 ppm (1H, tt). From these data, the product was identified to be a cyclic carbonate-modified siloxane having the following formula (Compound [IV]).

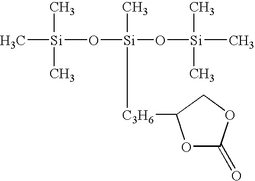

### Example 3

A reactor equipped with a stirrer, thermometer and reflux condenser was charged with 32 g of allyloxy propylene carbonate, 100 g of toluene, and 0.05 g of a 0.5 wt % chloroplatinic acid toluene solution. With stirring at 70° C., 33 g of pentamethyldisiloxane was added dropwise to the mixture. Reaction took place while the molar ratio of terminal unsaturated radicals to SiH radicals was about 0.9. After the completion of dropwise addition, the reaction solution was aged at 80° C. for 2 hours to complete the reaction. The reaction solution was precision distilled in vacuum, collecting a fraction of 124° C./13 Pa. In this way, a cyclic carbonate-modified siloxane was obtained in a yield of 90%. It had a viscosity of 19 mPa-s, a specific gravity of 1.015, and a purity of 96.1% as analyzed by gas chromatography. On analysis by ¹H-NMR using heavy acetone as the measuring solvent, the peaks observed included 0.1 ppm (15H, s), 0.45 ppm (2H, m), 1.51 ppm (2H, m), 3.39 ppm (2H, t), 3.61 ppm (2H, m), 4.27 ppm (1H, dd), 4.48 ppm (1H, dd), and 4.84 ppm (1H, m). From these data, the product was identified to be a cyclic carbonate-modified siloxane having the following formula.

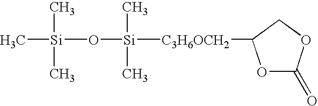

### Example 4

A reactor equipped with a stirrer, thermometer and reflux condenser was charged with 32 g of allyloxy propylene carbonate, 100 g of toluene, and 0.05 g of a 0.5 wt % chloroplatinic acid toluene solution. With stirring at 70° C., 49 g of 1,1,1,3,5,5,5-heptamethyltrisiloxane was added dropwise to the mixture. Reaction took place while the molar ratio of terminal unsaturated radicals to SiH radicals was about 0.9. After the completion of dropwise addition, the reaction solution was aged at 80° C. for 2 hours to complete the reaction. The reaction solution was precision distilled in vacuum, collecting a fraction of 137° C./13 Pa. In this way, a cyclic carbonate-modified siloxane was obtained in a yield of 73%. It had a viscosity of 26 mPa-s, a specific gravity of 1.004, and a purity of 97.7% as analyzed by gas chromatography. On analysis by ¹H-NMR using heavy acetone as the measuring solvent, the peaks observed included 0.1 ppm (21H, ss), 0.51 ppm (2H, m), 1.60 ppm (2H, m), 3.47 ppm (2H, t), 3.70 ppm (2H, m), 4.36 ppm (1H, dd), 4.56 ppm (1H, dd), and 4.91 ppm (1H, m). From these data, the product was identified to be a cyclic carbonate-modified siloxane having The following formula.

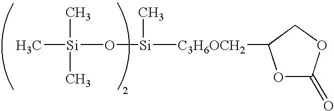

### Comparative Example 1

A reactor equipped with a stirrer, thermometer and reflux condenser was charged with 100 g of vinyl ethylene carbonate, 100 g of toluene, and 0.05 g of a 0.5 wt % chloroplatinic acid toluene solution. With stirring at 60° C., 143 g of pentamethyldisiloxane was added dropwise to the mixture. Reaction took place while the molar ratio of terminal unsaturated radicals to SiH radicals was about 0.9. After the completion of dropwise addition, the reaction solution was aged at 80° C. for 2 hours to complete the reaction. The reaction solution was precision distilled in vacuum, collecting a fraction of 99° C./5 Pa. In this way, a cyclic carbonate-modified siloxane was obtained in a yield of 52%. It had a viscosity of 9.3 mPa-s, a specific gravity of 0.996, and a purity of 98.9% as analyzed by gas chromatography. On analysis by ¹H-NMR using heavy acetone as the measuring solvent, the peaks observed included 0.10 ppm (15H, s), 0.55 ppm (2H, m), 1.78 ppm (2H, m), 4.15 ppm (1H, dd), 4.59 ppm (1H, dd), and 4.78 ppm (1H, m). From these data, the product was identified to be a cyclic carbonate-modified siloxane having the following formula.

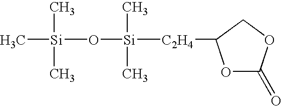

### Comparative Example 2

A reactor equipped with a stirrer, thermometer and reflux condenser was charged with 100 g of vinyl ethylene carbonate, 100 g of toluene, and 0.05 g of a 0.5 wt % chloroplatinic acid toluene solution. With stirring at 70° C., 216 g of 1,1,1,3,5,5,5-heptamethyltrisiloxane was added dropwise to the mixture. Reaction took place while the molar ratio of terminal unsaturated radicals to SiH radicals was about 0.9. After the completion of dropwise addition, the reaction solution was aged at 80° C. for 2 hours to complete the reaction. The reaction solution was precision distilled in vacuum, collecting a fraction of 120° C./7 Pa. In this way, a cyclic carbonate-modified siloxane was obtained in a yield of 42%. It had a viscosity of 13 mPa-s, a specific gravity of 0.990, and a purity of 96.1% as analyzed by gas chromatography. On analysis by ¹H-NMR using heavy acetone as the measuring solvent, the peaks observed included 0.1 ppm (21H, ss), 0.56 ppm (2H, m), 1.78 ppm (2H, m), 4.15 ppm (1H, dd), 4.76 ppm (1H, dd), and 4.63 ppm (1H, tt). From these data, the product was identified to be a cyclic carbonate-modified siloxane having the following formula.

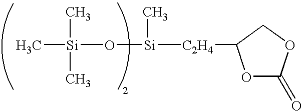

A comparison is made among the yields of Examples 1 to 4 and Comparative Examples 1 to 2. Comparative Examples 1 and 2 using ethylene carbonate gave yields of 52% and 42%, whereas Examples 1 to 4 gave yields of 90%, 97%, 90%, and 73%, demonstrating higher yields.

### Example 5

A reactor equipped with a stirrer, thermometer and reflux condenser was charged with 100 g of allyloxy propylene carbonate, 100 g of toluene, and 0.05 g of a 0.5 wt % chloroplatinic acid toluene solution. With stirring at 70° C., 93 g of trimethoxysilane was added dropwise to the mixture. Reaction took place while the molar ratio of terminal unsaturated radicals to SiH radicals was about 0.83. After the completion of dropwise addition, the reaction solution was aged at 90° C. for 2 hours to complete the reaction. The reaction solution was distilled in vacuum, collecting a fraction of 134° C./2 Pa. In this way, a cyclic carbonate-modified siloxane was obtained in a yield of 75 wt %. It had a viscosity of 21 mPa-s, a specific gravity of 1.1797, and a purity of 97.1% as analyzed by gas chromatography. On analysis by ¹H-NMR using heavy acetone as the measuring solvent, the peaks observed included 0.62 ppm (2H, m), 1.64 ppm (2H, m), 3.45 ppm (9H, s), 3.64 ppm (4H, m), 4.34 ppm (1H, m), 4.53 ppm (1H, m), and 4.90 ppm (1H, m). From these data, the product was identified to be a cyclic carbonate-modified siloxane having the following formula.

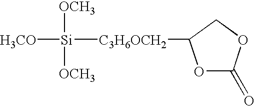

### Example 6

A reactor equipped with a stirrer, thermometer and reflux condenser was charged with 56 g of the cyclic carbonate-modified trimethoxysilane of Example 5, 104 g of trimethylmethoxysilane, and 80 g of methanol and cooled to −10° C. To the reactor was added 4 g of conc. sulfuric acid. While cooling at −10° C., 17 g of deionized water was slowly added to the mixture for hydrolysis. The mixture was stirred for 2 hours, after which it was allowed to resume room temperature, combined with toluene, and washed with water. The toluene layer was separated and dried over anhydrous sodium sulfate. Volatiles were distilled off in vacuum for 1 hour, and a fraction of 130° C./10 Pa was collected. In this way, a cyclic carbonate-modified siloxane as shown below was obtained in a yield of 91 wt %. It had a viscosity of 38 mPa-s, a specific gravity of 1.01, and a purity of 91.3% as analyzed by gas chromatography. On analysis by ¹H-NMR using heavy acetone as the measuring solvent, the peaks observed included 0.14 ppm (27H, s), 0.52 ppm (2H, m), 1.62 ppm (2H, m), 3.48 ppm (2H, t), 3.69 ppm (2H, m), 4.36 ppm (1H, dd), 4.56 ppm (1H, dd), and 4.92 ppm (1H, m). From these data, the product was identified to have the following structure.

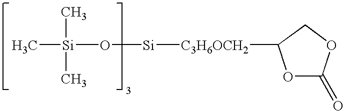

The reaction product was further analyzed for by-products, finding that it contained the following compounds.

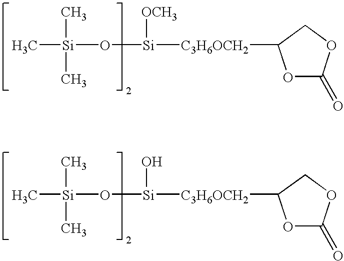

### Examples 7-10 and Comparative Examples 3-4

Preparation of Non-Aqueous Electrolytic Solution

Non-aqueous electrolytic solutions were prepared by dissolving the siloxanes of Examples 3 to 6 in a mixture of ethylene carbonate (EC) and diethyl carbonate (DEC) in the proportion shown in Table 1 and further dissolving LiPF₆ therein in a concentration of 1.3 mole/liter. For comparison purposes, a non-aqueous electrolytic solution free of the siloxane, and a non-aqueous electrolytic solution having 5% by volume of a polyether-modified silicone added instead were prepared.

TABLE 1

| | EC | DEC | Modified silane or siloxane | | |
|---|---|---|---|---|---|
| | | | | Viscosity | |
| Example | (vol %) | (vol %) | Compound | (mPa-s) | Vol % |
| 7 | 47.5 | 47.5 | Example 3 | 19 | 5 |
| 8 | 47.5 | 47.5 | Example 4 | 26 | 5 |
| 9 | 47.5 | 47.5 | Example 5 | 21 | 5 |
| 10 | 47.5 | 47.5 | Example 6 | 38 | 5 |
| Comparative | | | | Viscosity | |
| Example | (vol %) | (vol %) | Additive | (mPa-s) | Vol % |
| 3 | 50.0 | 50.0 | none | — | — |
| 4 | 47.5 | 47.5 | polyether- | 4 | 5 |
| | | | modified | | |
| | | | silicone* | | |

*The polyether-modified silicone used in Comparative Example 4 has the following formula.

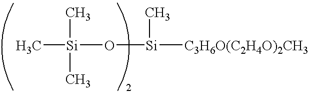

Preparation of Battery Materials

The positive electrode material used was a single layer sheet using LiCoO₂ as the active material and an aluminum foil as the current collector (trade name Pioxcel C-100 by Pionics Co., Ltd.). The negative electrode material used was a single layer sheet using graphite as the active material and a copper foil as the current collector (trade name Pioxcel A-100 by Pionics Co., Ltd.). The separator used was a porous polyolefin membrane (trade name Celgard® 2400 by Celgard, LLC).

Battery Assembly

A battery of 2032 coin type was assembled in a dry box blanketed with argon, using the foregoing battery materials, a stainless steel can housing also serving as a positive electrode conductor, a stainless steel sealing plate also serving as a negative electrode conductor, and an insulating gasket.

Battery Test (Cycle Performance)

The steps of charging (up to 4.2 volts with a constant current flow of 2.0 mA) and discharging (down to 2.5 volts with a constant current flow of 2.0 mA) at 25° C. were repeated 100 cycles. A percentage retention of discharge capacity was calculated provided that the discharge capacity at the first cycle was 100. The results are shown in FIG. 1.

It is seen from FIG. 1 that as compared with Comparative Example 3, Examples 7, 8 and 10 having cyclic carbonate-modified siloxanes added offer reduced drops of discharge capacity and improved cycle characteristics. The results are also superior to those of Comparative Example 4 having the known polyether-modified silicone added.

Japanese Patent Application No. 2005-265551 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A cyclic carbonate-modified organosilicon compound having the general formula (1) or (2):
R¹₍₄₋ₓ₎AₓSi (1)
R¹ₐA_{b}SiO_{(4-a-b)/2} (2)
wherein R¹ is each independently a monovalent radical selected from the group consisting of hydroxyl radicals, and alkyl, aryl, aralkyl, amino-substituted alkyl, carboxyl-substituted alkyl, alkoxy, and aryloxy radicals of 1 to 30 carbon atoms which may be substituted with halogens,
A is a cyclic carbonate radical of the general formula (3): 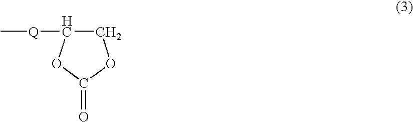
wherein Q is a divalent organic radical of 3 to 20 carbon atoms which may contain an ether or ester bond,
the subscript x is an integer of 1 to 4, a is a positive number of 1.0 to 2.5, b is a positive number of 0.001 to 1.5, and the sum of a+b is from 1.001 to 3.

2. A non-aqueous electrolytic solution comprising a non-aqueous solvent, an electrolyte salt, and the cyclic carbonate-modified organosilicon compound of claim 1.

3. The non-aqueous electrolytic solution of claim 2 wherein R¹ in formula (1) or (2) is an alkyl or fluoroalkyl radical of 1 to 6 carbon atoms.

4. The non-aqueous electrolytic solution of claim 2 wherein Q in formula (3) is —(CH₂)₃—.

5. The non-aqueous electrolytic solution of claim 2 wherein Q in formula (3) is —(CH₂)₃—O—CH₂—.

6. The non-aqueous electrolytic solution of claim 2 wherein the cyclic carbonate-modified organosilicon compound is present in an amount of at least 0.001% by volume based on the entire non-aqueous electrolytic solution.

7. The non-aqueous electrolytic solution of claim 2 wherein the electrolyte salt is a lithium salt.

8. A secondary battery comprising the non-aqueous electrolytic solution of claim 2.

9. An electrochemical capacitor comprising the non-aqueous electrolytic solution of claim 2.

10. A lithium ion secondary battery comprising the non-aqueous electrolytic solution of claim 2.
